(19) United States
(12) Patent Application Publication
(10) Pub. No.: US 2001/0027491 A1
(43) Pub. Date: Oct. 4, 2001

(54) Network communication system including metaswitch functionality

(76) Inventors: Michael S. Terretta, New Canaan, CT (US); Michael Alatrosev, Bridgeport, CT (US); John Alexander Edwards III, New Canaan, CT (US)

Correspondence Address: Basam E. Nabulsi, e-Media, LLC, 199 Elm Street, New Canaan, CT, 06840, US

(21) Appl. No.: 09/781,379

(22) Filed: Feb. 12, 2001

Related U.S. Application Data
(63) Continuation-in-part of application No. 09/535,422, filed on Mar. 27, 2000.

(51) Int. Cl. G06F 15/173; G06F 15/16

(52) U.S. Cl. 709/238; 709/203

(57) ABSTRACT

A system and method for supplying data to a user upon request are disclosed. The system and method include a redundant array of servers, e.g., media servers, commerce servers, and web servers, that isolate the public network from the private network. The array of servers includes a plurality of individual media servers, and a user database in data communication with an Internet service exchange server hub. A metaswitch is operatively associated with the Internet service exchange server hub and the redundant array of media servers, and is programmed to determine which of the individual media servers will supply data files to the user upon request based upon preprogrammed determination criteria. In a preferred embodiment, the metaswitch determines which of the media servers will supply the data files to the user based upon the first of the media servers to respond to a polling request from the metaswitch. The method and system of the disclosure may also advantageously include a distributor, a static redirector, a log analyzer and/or a metacache unit for managing file storage and access. The method and system of the present disclosure provide improved data transmission, e.g., delivery of multimedia files to users.

### CROSS-REFERENCE TO RELATED APPLICATION(S)

The present application is a continuation-in-part of co-pending patent application Ser. No. 09/535,422, entitled “Flat Network Communication System,” filed on Mar. 27, 2000, the contents of which are hereby incorporated by reference.

### BACKGROUND

1. Technical Field

The present disclosure relates to a method and system for facilitating efficient data transfer and communication and, more particularly, to a method and system for facilitating streaming and/or delivery of multimedia data, e.g., graphics, audio and/or video files, upon request by a user. The present disclosure further relates to a method and system for enhancing storage and efficient delivery of streaming files/content to user(s).

2. Background of the Related Art

Data communications across the Internet were initially text-only media. While the Internet, and particularly the World Wide Web, continues to service significant text-only transmissions, increasingly users of and content providers to the Web are focused on multimedia transmissions. Accommodating multimedia transmissions across the Internet implicates significant technical issues because of the huge amounts of data required to allow users to access and enjoy graphics, audio and/or video content. Accommodating these large data requirements is more easily addressed in the personal computer environment than in the networked world of the Internet. Successfully addressing the transmission of large data requirements across the Internet will allow an individual's personal computer to become a universal source of information and communication, operating as the functional equivalent of a television, radio, stereo and telephone.

Significant issues associated with multimedia transmissions across the Internet involve bandwidth and latency. A user's ability to receive the requisite amounts of data is dependent upon the amounts of data than can be transmitted across a network, a computer bus, and/or any of the other data pathways that are involved in data transmission. Bandwidth on the Internet is being increased at a rapid pace through improved technologies, including the movement toward cable and DSL (digital subscriber line) connections. Moreover, streaming technologies and protocols have been developed in an attempt to address the relatively narrow bandwidth available for multimedia transmissions, e.g., through traditional modem connections.

Streaming enables a personal computer, personal digital assistant (PDA), set top box, and the like (collectively referred to as a “PC”) to play a multimedia file as soon as the first bytes arrive at the PC, rather than requiring the personal computer to await downloading of the entire multimedia file. According to conventional streaming technology, multimedia files are transmitted using a “user datagram protocol” (UDP) rather than the “transmission control protocol” (TCP) associated with most Internet transmissions. A crucial difference between the two protocols is how they check for transmission errors. In the case of TCP protocol, the mistransmission of a packet of information across the Internet generally results in suspension of the transmission while a retransmission of the erroneous packet of data is requested and received. By contrast, the UDP protocol generally permits periodic mistransmissions of data packets without interrupting the transmission flow. The UDP protocol recognizes that, in receiving and processing multimedia transmissions, periodic missed or erroneous frames or data packets will not have a meaningfully adverse effect on the quality of the transmission. Indeed, the user may not notice the error in processing the transmission.

In general, streaming audio files across the Internet begins with a user clicking on a link to an audio source. In response, the Web browser contacts the Web server holding the current Web page and/or audio file. The server sends the user's browser a small file generally called a “metafile.” The metafile indicates where the user's browser can find the sound/audio file. The sound/audio file may be located on a multiplicity of possible servers, i.e., it need not be located on the Web server initially contacted by the browser. In addition, the metafile contains information on how to play the audio file. Generally, the metafile may direct a user's browser to a load balancer that may assess and identify a server among an array of servers to deliver the audio file to the user based upon criteria associated with the load balancer.

The metafile instructs the Web browser to launch the appropriate audio player. Audio players are generally plug-ins, i.e., mini-programs designed to work with a particular browser such as Netscape Navigator or Microsoft Internet Explorer. The audio player communicates with the audio server that will provide the sound file, and provides relevant information to the audio server, e.g., how fast the Internet connection is to the user's PC. Based on the speed of the connection, the audio server generally selects one of several versions of the audio file for transmission to the user. The audio server generally transmits higher quality sound, which requires greater bandwidth, over faster links, and lower quality sound over slower connections. The audio server transmits the audio file, via the Internet's network of servers, routers, etc., to the user's PC through a series of packets in user datagram protocol (UDP). Each step through the Internet's network of servers, routers, etc., may be termed a “hop” and potentially impedes, slows and/or degrades the data transmission passing therethrough.

When the data packets arrive at the user's PC, the system decompresses and decodes the data, sending the decoded results to a buffer, i.e., a small portion of the PC's RAM that holds a few seconds of sound. When the buffer fills up, the audio player starts to process the file through its sound card, turning the file data into voices, music and/or sounds, while the audio server continues to transmit additional aspects of the audio file through the Internet's network of servers and related infrastructure. This transmission modality can continue indefinitely. In the event the buffer is temporarily depleted of data, e.g., if the user accesses a different Web page, if the connection is poor, or if Internet traffic is high, thereby interfering with data transmission, the audio replay will cease. Once the buffer again accumulates sufficient data, the audio replay will resume. In the event the source of the audio data is a “live” performance, depletion of the buffer will cause the audio player to, in effect, skip portions of the performance, whereas if the source of the audio data is prerecorded, the audio replay will generally pick up where it left off.

Conventional video streaming operates in a comparable manner. Generally, a server includes a video capture expansion card that receives ordinary analog video signal from a source, either “live” feed or recorded tape, and converts the analog signal into digital information, e.g., at a rate of thirty frames per second. The video capture card typically transmits the digital information through a “codec” or compression/decompression algorithm to facilitate communication across the Internet. Interframe compression allows the server to compare adjacent frames and to transmit only those pixels that change from one frame to the next. For example, when the camera is still, the background is not transmitted after a key frame that established the background appearance. Conversely, when the camera pans, causing the background to change, the entire frame is transmitted, thereby creating a superceding key frame. Through interframe compression, less data is transmitted across the Internet when a camera is still or other aspects of the visual image remain unchanged. In addition to interframe compression, codecs typically skip frames to accommodate slower Internet links. Thus, the faster the Internet connection, the more frames that are transmitted to the user's PC and the smoother the video replay appears to the user.

The video server generally breaks up the compressed video data into one of two types of packets, based on the transmission protocol to be utilized. According to a first transmission protocol, IP (Internet provider) multicast packets are transmitted as a single signal to a computer acting as a multicast server. On a relative basis, the IP multicast uses less bandwidth than the alternative and more prevalent protocol, namely UDP. The multicast server duplicates the video signal received from the video server and transmits the duplicated signal to all requesting client PCs. By contrast, when using the user datagram protocol, no special network hardware, e.g., a multicast server, is required. Rather, UDP packets are sent to every client PC from the video server, thereby necessitating greater bandwidth. However, the UDP packets are generally more efficient in preventing gaps or pauses in the audio portion of the signal.

Upon receipt of the multimedia transmission, each PC decompresses the video and loads the data into a RAM buffer. From the buffer, the signal is split into video and audio components that are forwarded to the video and sound cards, respectively. As with pure audio streaming, video streams simply skip packets that cannot be processed in real time. However, unlike audio processing, a corrupted video packet can cause a defect that carries over to subsequent frames. To address this potential, the PC generally compares new frames with prior frames to detect errors and correct them by using visual information from an uncorrupted frame.

From a topological standpoint, three systems have been developed for delivering multimedia signals through a network of servers, e.g., across the Internet and/or the World Wide Web. With reference to the conventional prior art Internet system 100 depicted in FIG. 1, multimedia transmissions requested by a user are transmitted to the user's computer, e.g., in a home or at a university, via a web of networked computers. For example, a user 112 may request a multimedia file from his home that is stored in data center 102. To deliver the multimedia file to user 112, the data file is transmitted through data center 104, MAE East public hub 106, data center 108, ISP 110 and then on to user 112. Of course, FIG. 1 greatly simplifies the number of servers associated with the Internet, and the actual transmission of the requested multimedia file may, in fact, pass through many more servers, routers and the like, i.e, entail significantly greater “hops,” before arriving at the home of user 112. The arduous path from data center 102 to user 112, and the substantial electronic traffic encountered by data packets in route, greatly impedes the speed and reliability of multimedia data transmission to end users.

Referring to FIG. 2, a second prior art system 120 for transmitting data packets to end users is schematically depicted. This second system 120 may be designated a “terrestrial edge” system, and it differs from the conventional system 100 depicted in FIG. 1 in that master data center end servers facilitate data transmission between and among peripheral data centers, thereby bypassing central hubs, such as MAE East public hub 106, to a limited degree. More particularly, according to system 120 of FIG. 2, user 112 is able to access multimedia files stored on master data center 122 by way of ISP 110 and data center 108. Media servers 124 and 126 permit unicasting, or “one-to-one” streaming, of multimedia files. However, to the extent the desired multimedia file is located at data center 102, the same tortuous path through MAE East public hub 106 is required to transmit the file to user 102. Moreover, database activity related to user password, account number, billing and the like, must pass through standard Internet channels to reach user database 130, thereby greatly increasing latency and packet loss associated with streaming file delivery.

A third prior art system 140 is schematically depicted in FIG. 3. System 140 utilizes satellite delivery technology to deliver multimedia files to users. According to satellite system 140, master data center 122 contains media servers 124 that communicate with a satellite transmitter 142 to transmit multimedia data packets to satellite 144. Satellite dishes 146 are located at various ISP locations 110 to receive data transmissions from satellite 144. Data transmission using a satellite distribution model achieves desirable multicasting functionality and does not involve incremental transmission costs for each receiving dish 146, thereby potentially reducing or controlling costs associated with stream distribution. However, satellite transmissions are unidirectional, i.e., data is transmitted from a master data center to the ISP and then on to the user. Therefore, the satellite transmission model cannot effectively operate in circumstances where data contained in a central database, e.g., user database 130, must be accessed in connection with the transmission of a multimedia file to a user. In such circumstances, multimedia content providers generally utilize a terrestrial edge system, e.g., system 120 depicted in FIG. 2, with its inherent limitations rather than satellite method 140. Moreover, there are innumerable ISPs located around the world, and it is a significant logistical issue to position a receiving dish at each such location. Thus, a satellite system poses issues that impede its commercial adoption and use.

Despite the extensive effort and investment expended to date, current technologies provide limited ability to reliably and efficiently deliver multimedia files to end users. Current systems generally involve tortuous communication channels to deliver files from media servers to end users, thereby significantly increasing the likelihood that mistransmissions and/or communication traffic will interfere with or impede the continuous delivery of data packets. Moreover, simultaneous communication with data contained in user databases may not be efficiently achieved with several current data transmission systems, thereby limiting the utility and effectiveness of such systems for widespread use. A system and method for facilitating efficient data transfer and communication, particularly for transmission of multimedia data packets, is therefore needed. Moreover, a method and system for enhancing storage and efficient delivery of streaming files/content to user(s) would greatly enhance the scalability and utility of streaming applications and overall adoption of streaming technologies.

### SUMMARY OF THE DISCLOSURE

The present disclosure is directed to a new and useful system and method for facilitating efficient data transfer and communication and, more particularly, to a method and system for facilitating streaming of multimedia data, e.g., graphics, audio and/or video files, upon request by a user. The present disclosure is further directed to a method and system for enhancing storage and efficient delivery of streaming files/content to user(s).

The system and method for supplying data files to a user upon request generally includes a redundant array of media servers (RAMS), a redundant array of web servers (RAWS), a redundant array of commerce servers (RACS), and a user database in data communication with an Internet service exchange server hub. The RAMS generally includes a plurality of individual media servers that communicate with a unique “metaswitch” through a fully redundant network fabric. The metaswitch is operatively associated with the Internet service exchange server hub and the redundant array of media servers, and is advantageously programmed to determine which of the individual media servers will supply data files to the user upon request based upon preprogrammed determination criteria and information gleaned from the file delivery system, as described herein.

According to the present disclosure, the system and method advantageously operate within two distinct network environments: a public network that includes, inter alia., the Internet service exchange hub and the user, and a private network that includes, inter alia., the databases associated with supplying multimedia content to a user. The RAMS, the RAWS and/or the RACS are deployed according to the present disclosure at the interface between the public and the private network. The RAMS, the RAWS and/or the RACS receive communications from the public network, e.g., requests for “live” or on-demand content, but do not allow such requests to directly enter the private network that is effectively hidden from view or detection by the public network. Rather, the RAMS, the RAWS and/or the RACS at the interface between the public and the private network, upon receipt of the communication from the public network, forwards an independent communication to the database(s) contained in the private network, e.g., the user database, the content database, the commerce database and/or the stream files and, upon receipt of a communication from the database(s), forwards a corresponding communication to the public network, e.g., the user. Thus, the RAMS, the RAWS and/or the RACS at the interface between the public and the private networks ensure the security of the database(s) within the private network, i.e., provide the principal functionality of a firewall, without creating the latency issues associated with typical firewalls. Indeed, the security offered by the RAMS, the RAWS and/or the RACS according to the present disclosure surpasses the security offered by typical firewalls currently available.

In a preferred embodiment, the metaswitch determines which of the media servers will supply the data files to the user based upon the first of the media servers to respond to a polling request from the metaswitch. The method and system of the disclosure may also advantageously include a distributor, a static redirector, a log analyzer and/or a metacache unit for managing file storage and access. The method and system of the present disclosure provide improved data transmission, e.g., delivery of multimedia files to users.

A network communication system is also advantageously provided according to the present disclosure, the system delivering a media file to a user upon request. The system generally includes a plurality of media servers configured as a redundant array of media servers. Each of the media servers communicates with at least two levels of media file storage and preferably three levels of media file storage (RAM, hard drive, and network attached storage). The system advantageously includes a metaswitch that communicates with the redundant array of media servers and is adapted to receive communications from and transmit communications to the user.

The metaswitch typically includes a stream redirector that is adapted to redirect a user to one of the media servers within the redundant array of media servers to access the desired media file. The metaswitch also typically includes a content collection that includes a listing of media files contained within the media storage, and a server collection that includes a listing of the media servers and health indicia for each of the media servers. A health monitor is generally provided that periodically collects measurements related to media server performance metrics. The health monitor also updates the health indicia for the media servers within the server collection based on the periodic collection of performance metrics.

A popularity engine is generally included as part of the metaswitch, the popularity engine tracking user requests for media files that are stored within the media storage and issuing commands to reposition the media files based upon the tracking information. A file mover is provided that responds to commands from the popularity engine and repositions media files within media storage levels. The stream redirector within the metaswitch thus advantageously redirects a user to an appropriate level of media file storage. The redirection of the user is generally based on input from the content collection and the server collection.

### BRIEF DESCRIPTION OF THE DRAWINGS

So that those having ordinary skill in the art to which the disclosed system and method appertains will more readily understand how to employ and use the same, reference may be made to the drawings wherein like reference numbers designate the same or similar structures:

FIG. 1 is a schematic depiction of a prior art system for transmitting information using the Internet;

FIG. 2 is a schematic depiction of a second prior art system for transmitting information using, at least in part, a terrestrial edge server system;

FIG. 3 is a schematic depiction of a further prior art system for transmitting information using, at least in part, a satellite system;

FIG. 4 is a schematic depiction of a system for transmitting information according to the present disclosure;

FIG. 5 is a schematic depiction of aspects of a system for transmitting information; the upper portion of FIG. 5 depicts a prior art system for transmitting information, whereas the lower portion depicts a system according to the present disclosure. The totality of FIG. 5 depicts interaction between a system according to the present disclosure and a prior art system;

FIG. 5A is a schematic depiction of system 200 according to the present disclosure, shown in conjunction with portions of the Internet backbone;

FIG. 6 is a schematic depiction of aspects of an alternate system for transmitting information according to the present disclosure;

FIG. 7 is a schematic depiction of aspects of a system for transmitting information according to the present disclosure;

FIG. 8 is a schematic depiction of alternative aspects of a system for transmitting information according to the present disclosure;

FIG. 9 is a schematic depiction of aspects of a system for transmitting information according to the present disclosure; and

FIG. 10 is a schematic illustration of components/operation of a metaswitch according to the present disclosure.

### DETAILED DESCRIPTION OF PREFERRED EMBODIMENT(S)

The present disclosure provides a novel and unique system and method for facilitating efficient data transfer and communication and, more particularly, to a unique method and system for facilitating streaming of multimedia data, e.g., graphics, audio and/or video files, upon request by a user. The system and method of the present disclosure overcomes limitations of prior art systems, thereby improving the efficiency, reliability and speed associated with multimedia file transmission to user's from remote network locations. Although the present disclosure describes in detail applicability of the improved system and method in the context of multimedia file transfer, the present disclosure has applicability and offers potential benefits to a wide range of file transfer modalities, as will be readily apparent to persons of skill in the art based on the teachings contained herein.

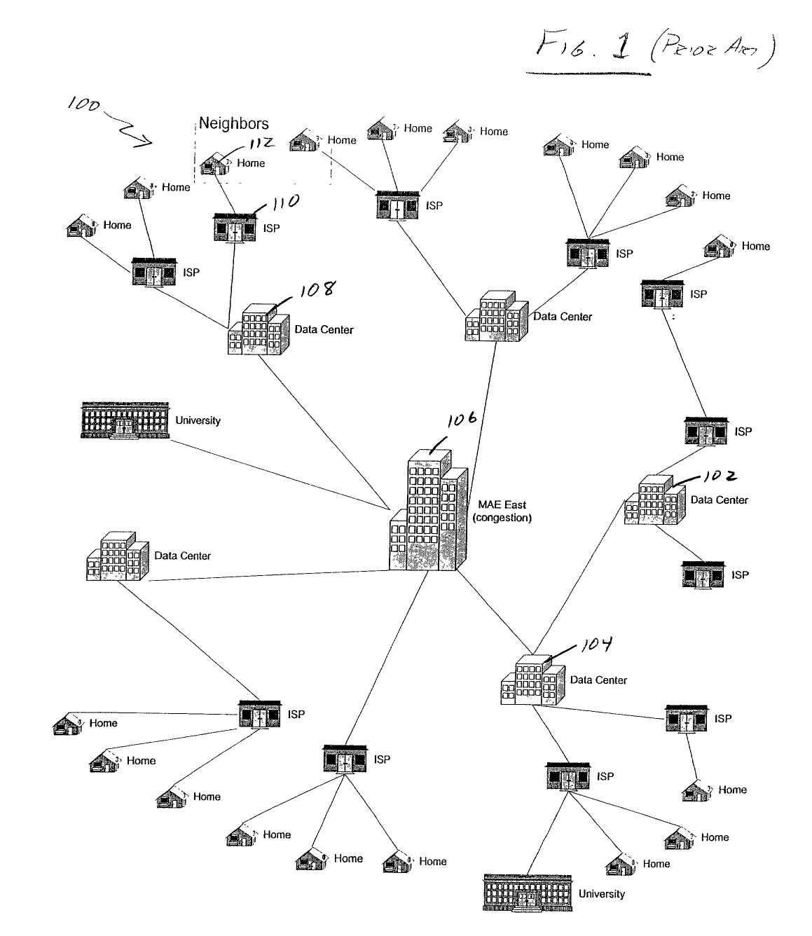

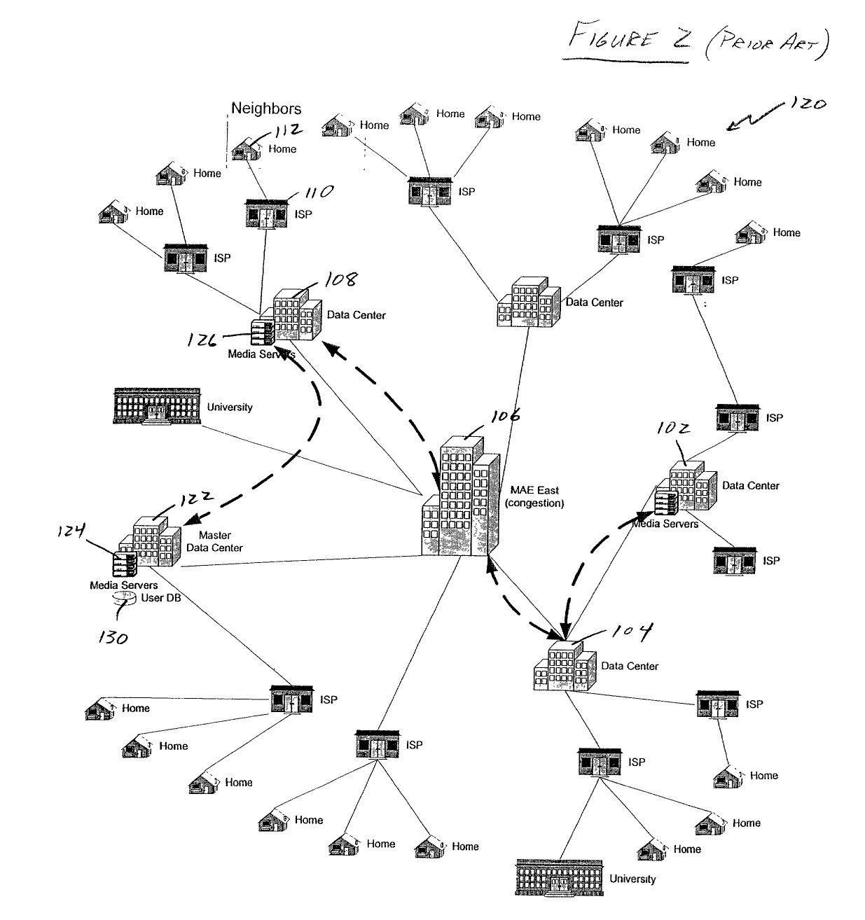

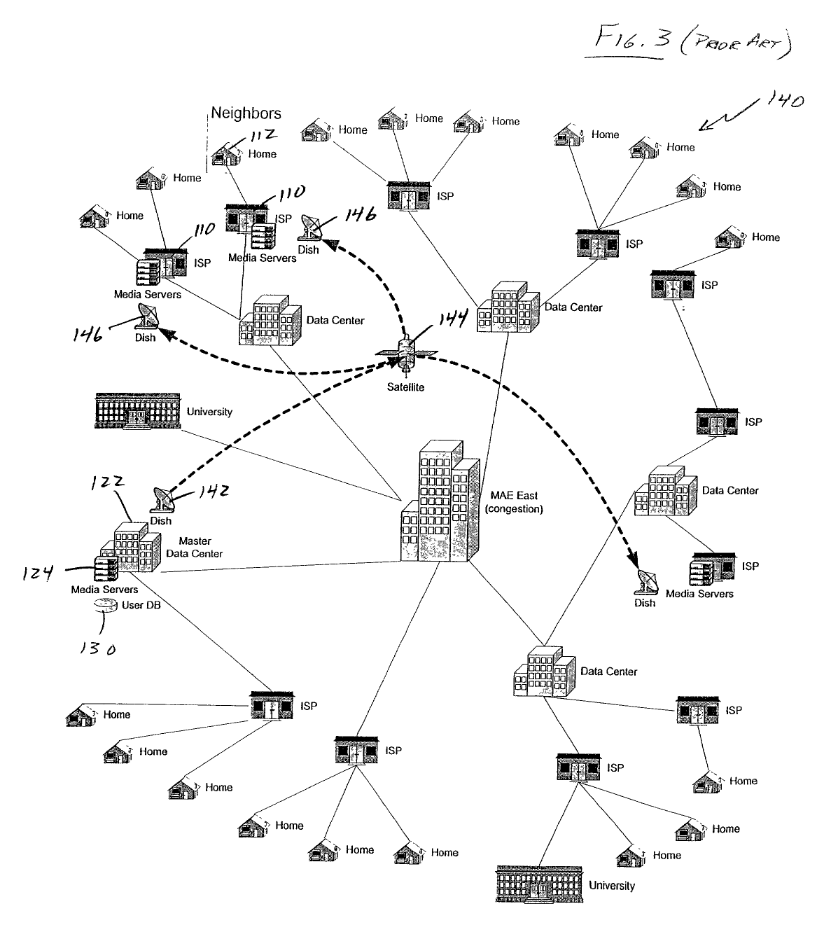

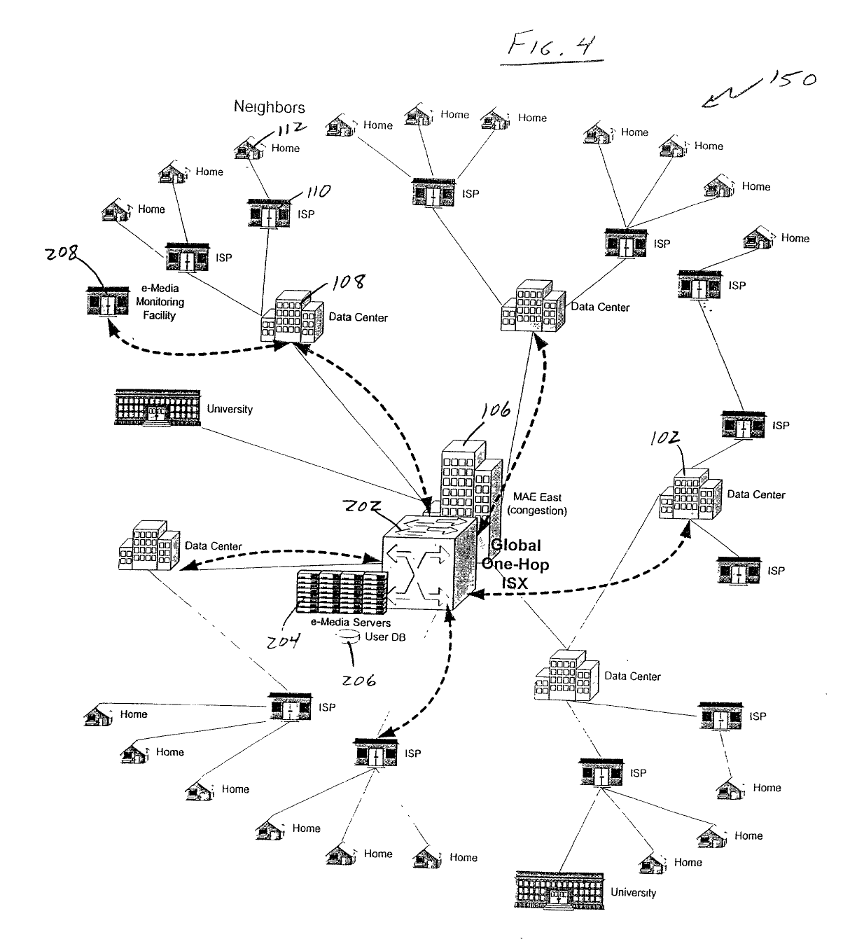

With reference to FIG. 4, a schematic depiction of a communication system 150 according to the present disclosure is provided. As with the prior art systems 100, 120 and 140 of FIGS. 1-3, system 150 allows user 112 to access information from distant data centers, e.g., data center 102, through a network of servers and related system infrastructure, including MAE East public hub 106, data center 108 and ISP 110. However, unlike prior art systems 100, 120 and 140 depicted in FIGS. 1-3, system 150 includes an Internet Service Exchange (ISX) 202 that is adapted to electronically communicate with or independent of (i.e., “above,” separate from, or as a bypass to) the Internet backbone, e.g., MAE East public hub 106. Moreover, ISX 202 includes direct, private connectivity to a plurality of data centers, e.g., data centers 102, 108. Thus, ISX 202 effectively functions as a private hub through which ISPs and content providers are able to bypass, at least in part, the congested central Internet servers, e.g., MAE East public hub 106.

ISX servers have been established and are available through commercial enterprises such as AboveNet Communications, a wholly owned subsidiary of Metromedia Fiber Network. ISX servers offer the potential for “one-hop access” to the Internet backbone. Co-located clients that utilize ISX servers potentially benefit from a direct communicative route to backbone connectivity. Connectivity is achieved through “private peering” arrangements and relationships that bypass the public exchange hubs, e.g., MAE East 106, and ensure clean connectivity to a multiplicity of backbone data centers and ISPs around the country and the world.

According to the system and method of the present disclosure, multimedia servers 204 for delivery of multimedia files, e.g., graphics, audio and video files, are concentrated at ISX server hubs 202. These multimedia servers 204 include network cards that communicate directly through the ISX server hub 202 to peering data centers, e.g., data centers 102, 110. In addition, according to the present disclosure, user database 206 is co-located with multimedia servers 204, thereby facilitating direct access to essential data concerning users, e.g., user 112, in connection with the supply of multimedia files upon request. For example, user information associated with the supply of multimedia files to user(s) may include account numbers, billing information, passwords and the like. Through co-location of user database 206 with multimedia servers 204 in association with ISX server hub 202, the system and method of the present disclosure facilitates rapid and efficient transfer of multimedia files, e.g., through data center 108, ISP 110 and to user 112.

One or more monitoring facilities 208 may optionally be provided in remote locations to monitor the delivery of multimedia files from multimedia servers 204. Such remote monitoring is facilitated by the direct connectivity afforded by ISX server hubs 202 to distributed data centers, e.g., data centers 102, 108. Individuals located in monitoring facilities 208 are responsible for ensuring proper operation of the systems associated with delivery of the multimedia files to user(s), including interaction with the user database(s), and because the ISX server hub 202 maintains a private peering arrangement with data center(s), e.g., data center 108, such individuals are able to monitor system performance through electronic connection with the distributed data center(s), e.g., data centers 102, 108.

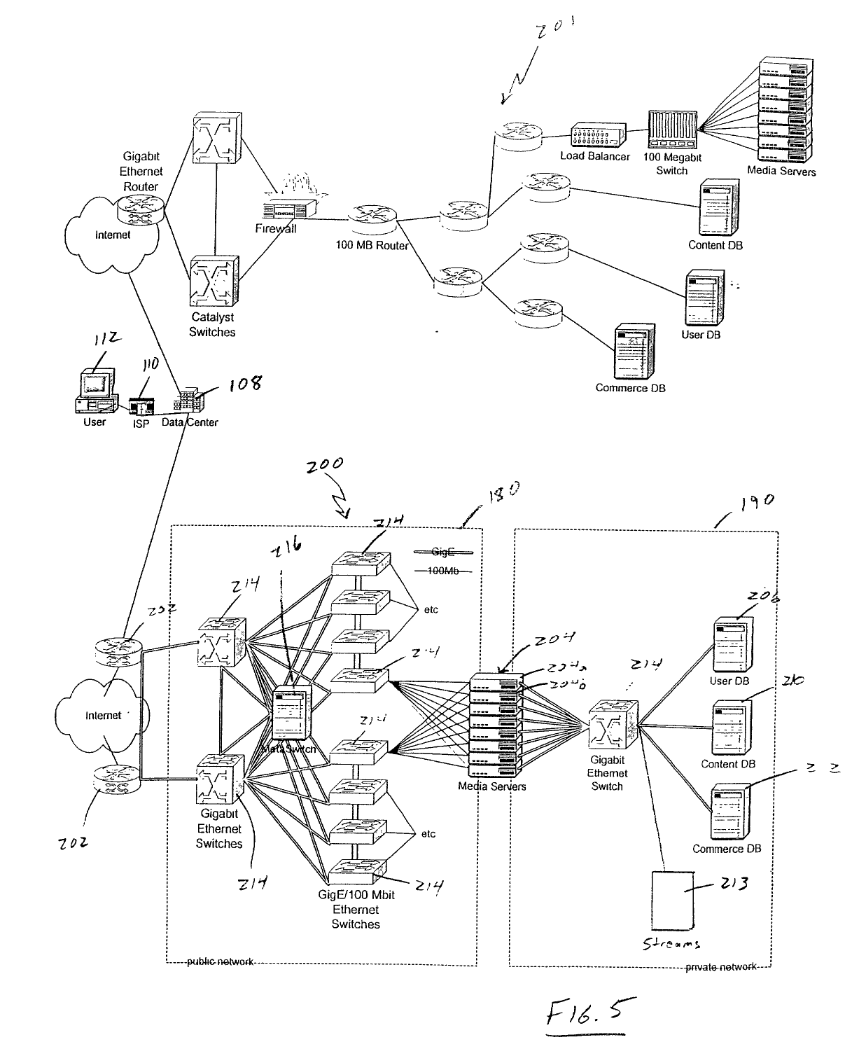

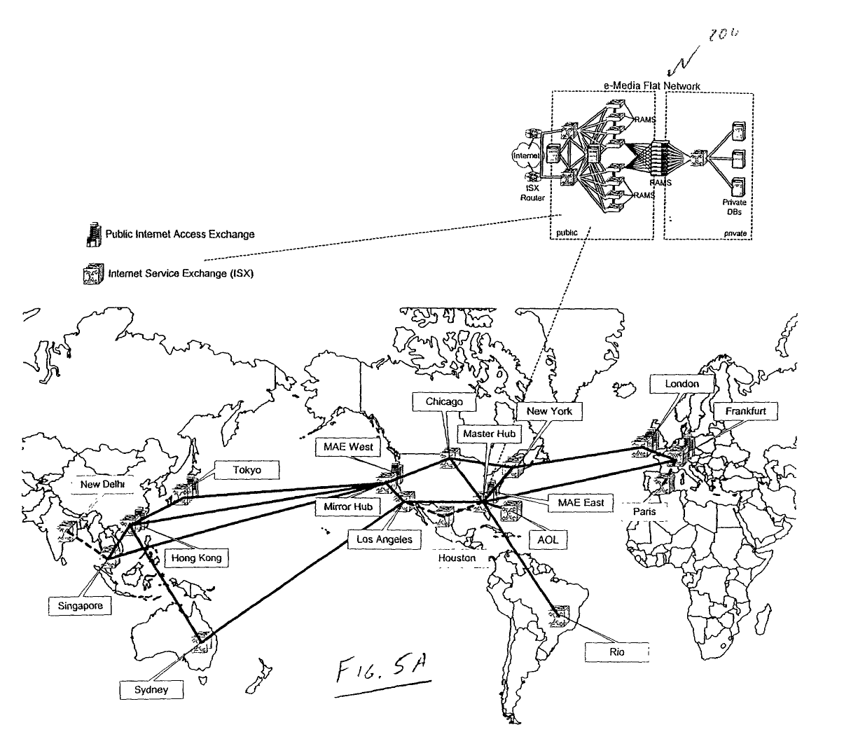

Turning to FIG. 5, system 200 according to the present disclosure includes multimedia servers 204. Interaction between multimedia servers 204 and, inter alia., user database 206, ISX server hub 202 and data center 108 are schematically depicted. Of note, the media servers 204 are located at the interface between the public network, shown schematically by phantom line 180 and the private network encompassed within system 200, shown schematically by phantom line 190. In a preferred system and method according to the present disclosure, at least three separate databases and a source of “live” or streaming content are maintained or contained within the private network, namely user database 206, content database 210, commerce database 212 and streaming files 213.

Each database serves a distinct function in the context of providing multimedia data delivery and/or revenue generation according to the present disclosure. As noted previously, user database 206 contains information related to potential recipients of the multimedia files, e.g., registration information, passwords, billing information and the like. Content database 210 typically contains on-demand multimedia files for delivery to user(s), e.g., graphics, audio and video files, for streaming to users. Streaming files 213, i.e., real-time multimedia data streams, are fed directly to switch 214, e.g., a gigabit Ethernet switch. Delivery of the multimedia files to users is typically achieved using standard protocols, as discussed hereinabove. Commerce database 212 may include advertising links and related commercial content for delivery to users in conjunction with multimedia file delivery. Of note, servers associated with the respective databases are preferably maintained on isolated, private networks, thereby enhancing the speed with which data may be transmitted, e.g., through media servers 204, to ISX server hub 202.

As shown in FIG. 5, media server 204 preferably comprises an array of individual media servers 204a, 204b, etc. in parallel according to the present disclosure, i.e., media server 204 defines a redundant array of media servers or “RAMS.” Advantageously, the direct or private connection of media servers 204 to, inter alia., ISX server hub 202 in the public network bounded by phantom line 180, and the separate direct or private connection of media servers 204 to, inter alia., databases 206, 208, 212 in the private network bounded by phantom line 190, advantageously isolates the private network from the public network, e.g., access through the Internet. Based on this advantageous isolation, the need for a separate firewall is eliminated, thereby improving performance and eliminating typical latency and congestion associated with data transmission through a conventional firewall application. Indeed, according to the present disclosure, media servers 204 function as an effective firewall in the context of the system schematically depicted in FIG. 5.

To illustrate benefits and/or advantages associated with the system and method of the present disclosure, the upper portion of FIG. 5 schematically depicts a prior art system 201 that is also adapted to feed multimedia content to a user by way of data center 108. Of note, prior art system 201 includes, inter alia., a firewall, a router farm, and a load balancer between the data center and the media servers. Each of these additional components add to the decision-making delays and congestion associated with accessing content and supplying such content to a user upon request. Unlike prior art system 201, the advantageous system 200 disclosed herein locates RAMS 204 at the interface between the public and private networks, and significantly improves reliability and efficiency of data transmission, while reducing latency.

The present system may also include a redundant array of web servers (RAWS) and/or a redundant array of commerce servers (RACS) in parallel with multimedia servers 204 to advantageously facilitate data transmission between database servers (e.g., databases 206, 210, 212 and streaming files 213) and user(s). The RAWS and/or RACS are also advantageously positioned at the interface between the public and private networks, thereby further enhancing the performance and reliability of systems and methods for transmitting data to a user according to the present disclosure. Indeed, a RAWS and/or a RACS may advantageously provide superior security to databases within the private network, as compared to prior art firewall applications.

Through the server redundancy disclosed herein, each individual server, e.g., 204a, 204b, etc., is provided with multiple paths to the database servers in the private network and/or the ISX server hub(s) in the public network, thereby ensuring relatively failsafe data transmission. In addition, in the event one or more of the individual servers fails, a controller (metaswitch 216 discussed hereinbelow) will recognize the failure and adapt the system to bypass the failure, while providing full access to requested files and data. Moreover, the failed server(s) can be replaced on the fly, i.e., hot swapped, as is known in the art, and the controller can cause the new server to be rebuilt with all of the data from the failed server.

A plurality of conventional Ethernet switches 214 is typically provided according to the system and method of the present disclosure. The plurality of Ethernet switches 214 (e.g., GigE/100 Mbit) provides a fully redundant network fabric for data transmission to and from media servers 204. According to the present disclosure, a single metaswitch 216 communicates with the plurality of Ethernet switches 214, e.g., electronically and/or optically, and then through to media servers 204. As noted hereinabove, media servers 204 advantageously isolate the public network (where metaswitch 216 is located) from the private network. Communications received from metaswitch 216 by media servers 204 are relayed to a plurality of database(s), e.g., database 206, 210, 212, within the private network 190 through private peering relationships. Metaswitch 216 also communicates, e.g., electronically and/or optically, with a further set of Ethernet switches 214, to ISX server hub(s) 202, and then on to data center(s) 108.

The topographical arrangement of system 200 advantageously eliminates the need for routers, firewalls and, based on unique aspects of metaswitch 216 discussed in greater detail hereinbelow, load balancing as compared to conventional multimedia delivery systems, such as prior art system 201. In effect, system 200 appears “flat” to end users because access to requested multimedia files is achieved through their ISP connection that communicates with ISX server hub 202, Ethernet switch(es) 214, metaswitch 216, and media servers 204. The “flat” topography achieved through the present disclosure eliminates multiple hops associated with conventional systems, e.g., on the order of six hops per transmission associated with routers, load balancing and a firewall, each of which results in latency and increased data file congestion.

Metaswitch 216 is provided with software enabling a series of advantageous functions to be performed. In particular, metaswitch 216 preferably establishes and maintains an open communication “pipe” to each individual media server as well as between a user, the requested content, and the usage database servers. If a communication pipe is broken or otherwise malfunctions, the server communicating through that pipe becomes unavailable and, in a preferred embodiment, an alarm is generated by metaswitch 216. Similarly, if metaswitch 216 receives abnormal performance data, the server responsible for generating the abnormal data is considered suspect and metaswitch 216 generates an alarm. On an ongoing basis, after transmission of data has commenced to a user according to the system of the present disclosure, metaswitch 216 monitors the data transmission for the limited purpose of ascertaining whether the integrity of the “pipe” has been compromised and whether data received through a pipe is abnormal in some respect.

Unlike prior art systems, the system of the present disclosure does not include a “load balancer” to distribute data communications among the media servers. Indeed, in prior art systems, a load balancer typically examines each piece of data and each server to determine if the requested server is active. It is the load balancer in prior art systems that is generally identified as the source of the datafiles requested by the user. However, in the system of the present disclosure wherein redundancy is built into the network fabric itself, the need for load balancing is obviated and the efficiency, speed and reliability of the system is greatly enhanced, while latency is reduced.

A further advantage associated with the design and operation of metaswitch 216 according to the present disclosure is that once metaswitch 216 points the user to an individual server as a source of the desired multimedia data, metaswitch 216 steps out of the data flow. Metaswitch 216, unlike prior art systems, is not involved in passing along each individual packet of data. Rather, metaswitch 216 monitors the system to ensure that the communication pipes are operational and delivering normal data, e.g., by monitoring periodic data packets, but does not evaluate each data packet as it passes from the media servers. In addition, the system of the present disclosure, through its sole decision-making metaswitch 216 and its redundant server arrays, eliminates the need for a plurality of routers to sort web traffic to web servers, media traffic to media servers, and database traffic to database servers. In this way, countless routers and servers that must handle and make decisions with respect to data packets are eliminated according to the present disclosure, thereby significantly improving system performance, speed and reliability.

Metaswitch 216 generally performs a series of additional functions. In particular, metaswitch 216 is multi-threaded, allowing it to poll each open pipe to each individual media server simultaneously and in real time. Data retrieved from polling of servers is mapped into a shared memory space for use by the dynamic switching algorithm within metaswitch 216. Thus, when metaswitch 216 intercepts a stream request from a user, it consults the shared memory space for server status data and decides to which server the user should be sent. Metaswitch 216 redirects the user to the selected server, causing the user to be “routed” across the appropriate portion of the system's switch fabric. Of note and as discussed in greater detail hereinbelow, metaswitch 216 (or a distributor, as described hereinbelow) may route the user to a geographically distant data center, if that data center is “closer” to the user in network topology metrics. To this extent, metaswitch 216 performs a load balancing function. However, once metaswitch 216 selects the server to which the user will be directed, the user will not be redirected to a different server unless the pipe fails or data from that server appears abnormal at a point in the future.

Metaswitch 216 additionally generally provides a series of database updating functions. For example, metaswitch 216 may update user database 206 with information about the user's properties, activity and preferences, may update the content database 210 with information about the content's popularity, and/or may update the commerce database 212 with fulfillment data based on the user's usage of content. As will be readily apparent, additional database updates may be accomplished by metaswitch 216, as will be readily apparent to persons skilled in the art of data collection associated with Internet usage. According to the present disclosure, the user's connection to the media server is maintained until the user disconnects or the server experiences an interruptive issue. As shown in FIG. 5A, system 200 is adapted to operate with or independent of the Internet backbone.

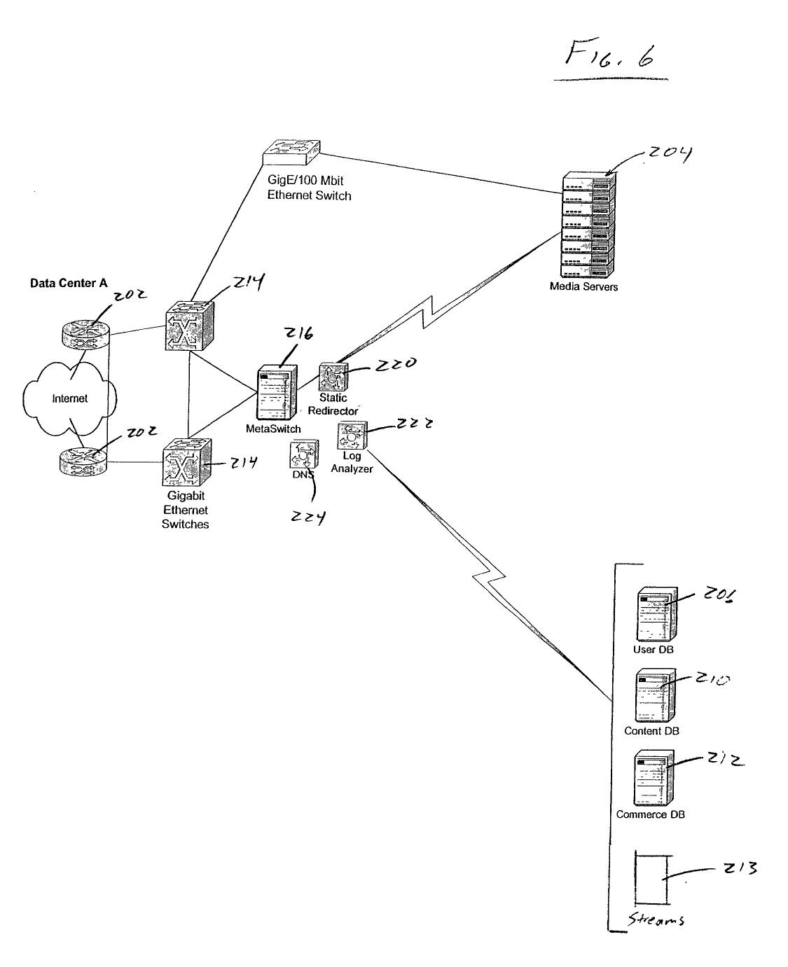

In an alternative system 250 according to the present disclosure which is schematically depicted in FIG. 6, metaswitch 216 is supplemented by static director 220, log analyzer 222 and DNS (Domain Name Server) server 224. Alternative system 250 has particular applicability as a backup to system 200 (FIG. 5). For example, if metaswitch 216 fails to perform one or more of the functions described hereinabove, alternative system 250 contemplates that metaswitch 216 may enter a “passive mode.” When in its passive mode, metaswitch 216 receives functional support from the supplemental components identified herein so as to provide needed functionality within system 250. Thus, in general terms, static redirector 220 sends the user to an appropriate server based on data from DNS server 224 that determines the server to use for each request. Usage data is stored for subsequent processing by a log analyzer 222 that functions to update the database servers.

In accordance with system 250, metaswitch 216 establishes and maintains an open pipe to its internal log files and is pre-programmed with a list of media servers. If a media server fails, an engineer or technician manually removes the failed server from the list programmed into metaswitch 216. Optionally, the list of media servers programmed into metaswitch 216 may be “balanced” to allocate differing amounts of traffic to various media servers, as is known to persons skilled in the art. If a media server provides abnormal data or otherwise malfunctions, the engineer/technician may decrease that server's allocation within the programmed “balancing” or may remove the server from the programmed list in its entirety. Generally, the programmed list is maintained in the memory of metaswitch 216, and may only be modified or updated by an engineer/technician.

According to method 250, metaswitch 216 is adapted to intercept a stream request from a user and direct the user to the next media server in the pre-programmed list of media servers. Metaswitch 216 may route the user to a geographically distant data center if the distant data center is “closer” to the user in network topology metrics. Metaswitch 216 also preferably functions to: (i) update the user log with information about the user's properties, activity and preferences; (ii) update the content log with information about the content's popularity; and (iii) and update the commerce log with fulfillment data based on the user's usage of content.

According to method 250, if metaswitch 216 enters its passive mode, as described hereinabove, log analyzer 222 is adapted to make a delayed connection between the user and the content/user database servers (i.e., databases 206, 210, 212 and stream files 213). In addition, log analyzer 222 is adapted to: (i) update the user database 206 with information about the user's properties, activities and preferences; (ii) update the content database 210 with information about the content's popularity; and (iii) update the commerce database 212 with fulfillment data based on the user's usage of content.

Thus, according to method 250, metaswitch 216 is programmed to redirect the user to the appropriate individual media server, causing the user to be “routed” across the appropriate portion of the switch fabric. The user's connection to the media server(s) is maintained until either the user disconnects normally, or the server experiences a performance issue. In the event transmission to a user is interrupted, the user is generally required to “quit” the media player application and restart it so as to be rerouted to an appropriate media server.

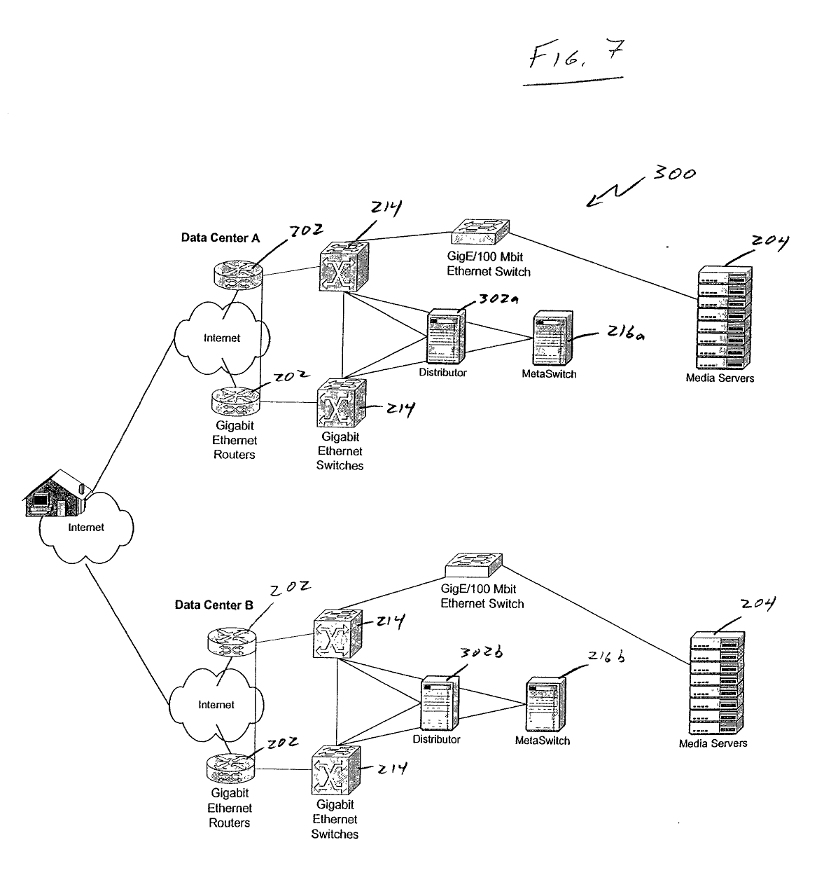

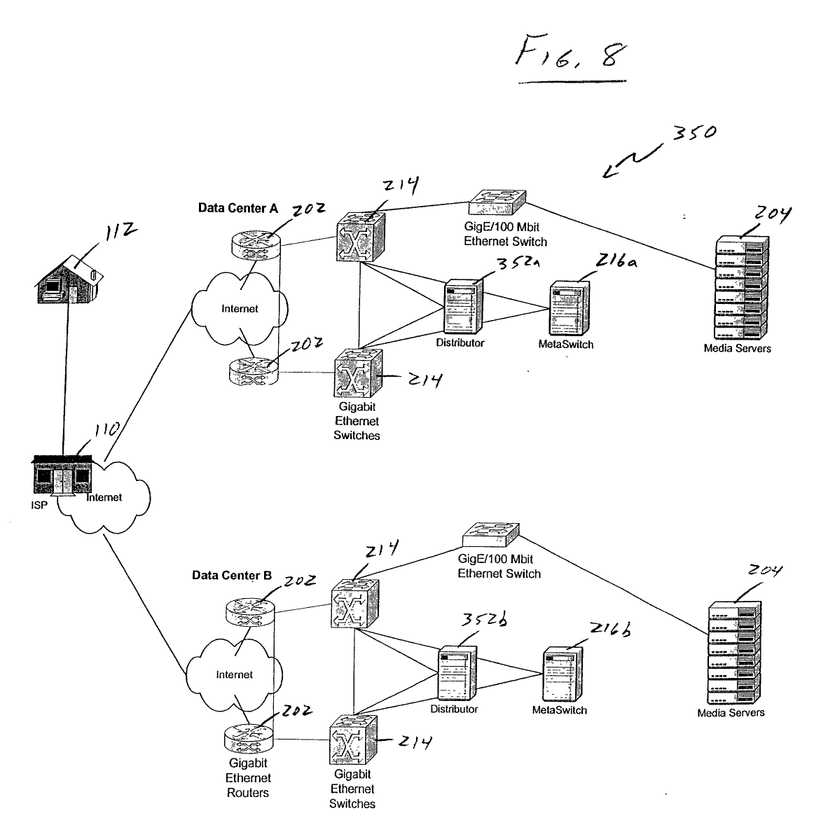

FIGS. 7 and 8 schematically depict alternative systems for data transmission utilizing a distributed data center environment according to the present disclosure. In a distributed data center environment, it is contemplated that the methods of the present disclosure may be advantageously operated in conjunction with multiple ISX servers 202 at distributed geographic locations. A user accessing media files in connection therewith will advantageously receive a data stream from the data center with the most rapid response time, e.g., lower latency for the data transmission yields smoother streaming quality.

According to a preferred embodiment schematically depicted in FIG. 7, system 300 operates efficaciously within a distributed data center environment by incorporating a distributor 302a, 302b at the physical location of each ISX server 202. Distributors 302a, 302b advantageously include software preprogrammed with information concerning the location of each metaswitch 216a, 216b that is located at the respective ISX server locations. Distributors 302a, 302b manage the traffic of data transmissions across geographically diverse data centers, routing users to the best available site from a single location request. Distributors 302a, 302b thus offer a choice of efficient traffic routing methods so that requests may be sent to the fastest responding site or to the best site based on server response time, amount of traffic, local conditions and proximity.

Commercially available distributors suitable for functioning as distributors 302a, 302b include the Intel NetStructure 7190 Multi-Site Director. Such commercially available products are generally used in networks to allocate traffic directly to all of the network's servers. However, functional limitations of such commercially available products include the fact that such products generally can support only a limited number of servers, are costly and do not scale effectively when every request must pass therethrough.

According to the present disclosure, distributors 302a, 302b overcome the limitations of prior uses of commercially available products, e.g., the NetStructure 7190 Multi-Site Director, by passing requests therethrough only once for each user. More particularly, distributors 302a, 302b are included in the data flow only in connection with the initial user request, and only in cooperation with metaswitchs 216a, 216b, rather than with all of the associated multimedia servers. Thus, distributors 302a, 302b are required to support only metaswitchs that, in turn, support a plurality of servers. Moreover, the scalability limitations of commercially available products are addressed according to the present disclosure by limiting the data transmissions to be handled thereby.

In operation, method/system 300 contemplates the receipt of a request from a user. Distributor 302a receives the request and directs all metaswitches 216a, 216b to respond to the request. According to the present disclosure, the metaswitch 216a, 216b that first responds to the inquiry/direction from distributor 302a is deemed the appropriate metaswitch to handle the request, regardless of physical location. Thus, a remotely located metaswitch may handle a request received by distributor 302a, even though a physically co-located metaswitch may appear to be the logical choice. Once the quickest responding metaswitch is determined, that request is transmitted to that metaswitch for distribution to the appropriate server(s) associated therewith.

Turning to FIG. 8, method/system 350 provides an alternative system for processing requests in a distributed data center environment according to the present disclosure. In this alternative system, method 350 takes advantage of a feature of the Internet's Domain Name System (DNS) where: (i) any number of DNS servers may be distributed across the Internet geography and topology; (ii) the user requests a location of a named metaswitch from the user's ISP which, in turn, requests the named metaswitch's location from all of the distributed DNS servers; (iii) the ISP accepts only the first response to reach it, and rejects all subsequently received responses; and (iv) the ISP transmits the first-received response to the user. This DNS server feature enables content providers to rely on mirrored DNS servers to provide redundancy should certain DNS servers become unreachable.

According to method 350, distributors 352a, 352b are specially modified DNS servers that purport to maintain a mirrored list of names, but actually only contain information about those servers located within the same facility. Thus, the response to the ISP's inquiry will be predetermined based on the programming of the modified DNS server, and will contain information concerning the metaswitch and media servers in the data center that responded to the user's ISP most rapidly. Accordingly, a request received by distributor 352a, 352b, i.e., the modified DNS server, will receive a response directing the user to use the metaswitch co-located with the ISX server hub, and when the metaswitch is in passive mode, instructs the user to use only the media servers co-located with the ISX server.

In operation, a system functioning according to method 350 receives a request from a user 112 by way of the user's ISP 110 for the appropriate media server(s) 204 to provide the desired multimedia data files. ISP 110 transmits the user's request to ISX server hubs 202. Each of the ISX server hubs 202 transmit the request to co-located distributor 352a, 352b, i.e., the modified DNS servers. Rather than polling all metaswitches 216a, 216b on a network-wide basis, distributors 352a, 352b are each limited to communication with the single co-located metaswitch. Based on the first metaswitch 216 to respond to its associated distributor 352a, 352b, the ISP 110 will receive a first response to the user's request, and will necessarily disregard all subsequent responses from other ISX server hubs. In this way, ISP 110 and user 112 will be directed to the first-responding metaswitch 216a, 216b which will, in turn, determine the appropriate media server(s) 204 to provide the desired content to user 112.

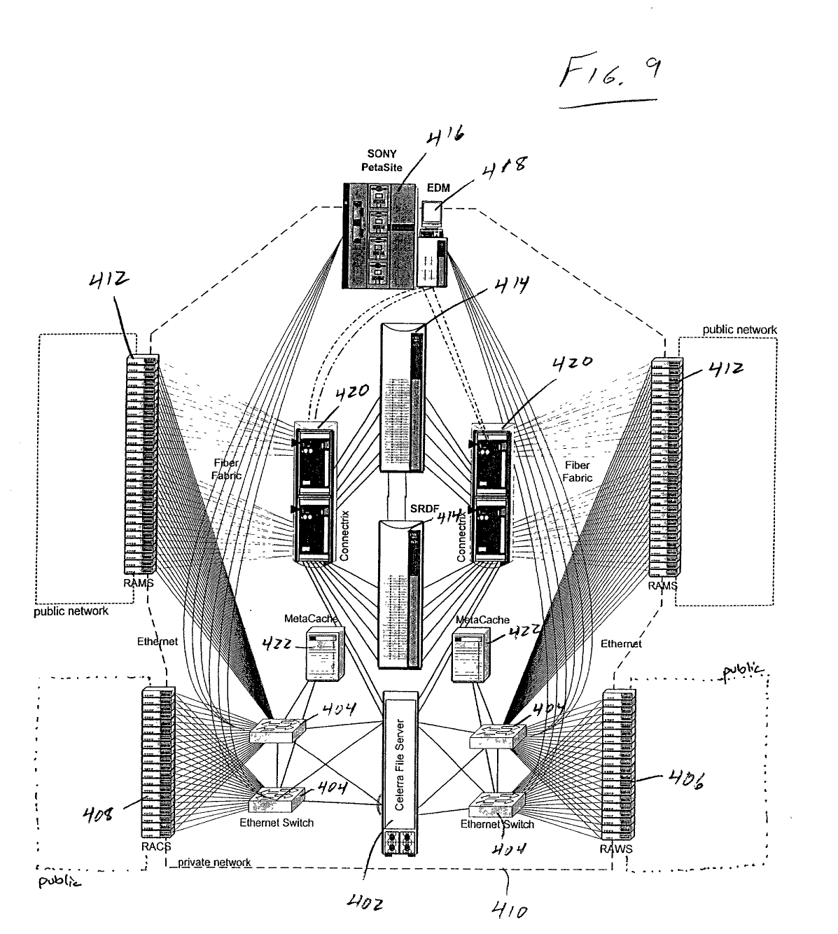

Turning to FIG. 9, a system 400 for advantageously storing multiple levels of stream content according to the present disclosure is schematically depicted. System 400 includes an EMC Celerra file server 402 that communicates electronically with, inter alia., a redundant array of commerce servers (RACS) 408 and a redundant array of web servers (RAWS) 406 via Ethernet switches 404. File server 402 is tuned for electronic commerce file server applications and is adapted to allow a complete “snapshot” of all commerce data to be taken at any time. RACS 408 preferably includes an independent instant storage system, in addition to the storage functionality afforded by file server 402. Similarly, RAWS 406 preferably includes significant independent storage functionality, e.g., multiple gigabytes, in addition to the terabytes of online storage provided by file server 402. RAWS 406 and RACS 408 preferably electronically communicate with each other via a private network 410.

One or more redundant arrays of media servers (RAMS) 412 are preferably provided within system 400, each of which contains independent storage levels. Electronic communication with and between RAMS 412 is facilitated by Ethernet switches 404. Additional file storage functionalities and capabilities may be advantageously deployed within system 400, e.g., one or more EMC Symmetrix units 414, each of which provides mirrored redundant online file storage with tens of terabytes of storage capacity, and deep storage units, e.g., a SONY PetaSite unit 416 that provides up to thousands of terabytes (perabytes) of data storage with any random file retrievable therefrom within seconds. A deep storage data manager 418 is typically provided in conjunction with the deep storage unit 416 to facilitate file control therewithin. Each of the media servers within RAMS 412 is preferably connected, e.g., electronically and/or optically, to the additional file storage unit(s) 414, e.g., EMC Symmetrix units, through ultra high speed fiber fabric 420 to facilitate speed and reliability of electronic communication therebetween.

Thus, according to method 400, four levels of file storage are provided, namely file server 402, additional file storage unit(s) 414, deep storage unit 416, and independent storage functionalities provided by the servers, i.e., RACS 408, RAWS 406 and RAMS 412. Control and coordination of these storage capabilities is managed, according to method 400, by metacache unit(s) 422. Preferably, redundant metacache units 422 are provided to ensure operational availability thereof. Metacache units 422 deploy and manage storage of files between and among the four storage levels to maximize speed, reliability and accessibility of the file data, based on algorithmic functionality provided within metacache units 422.

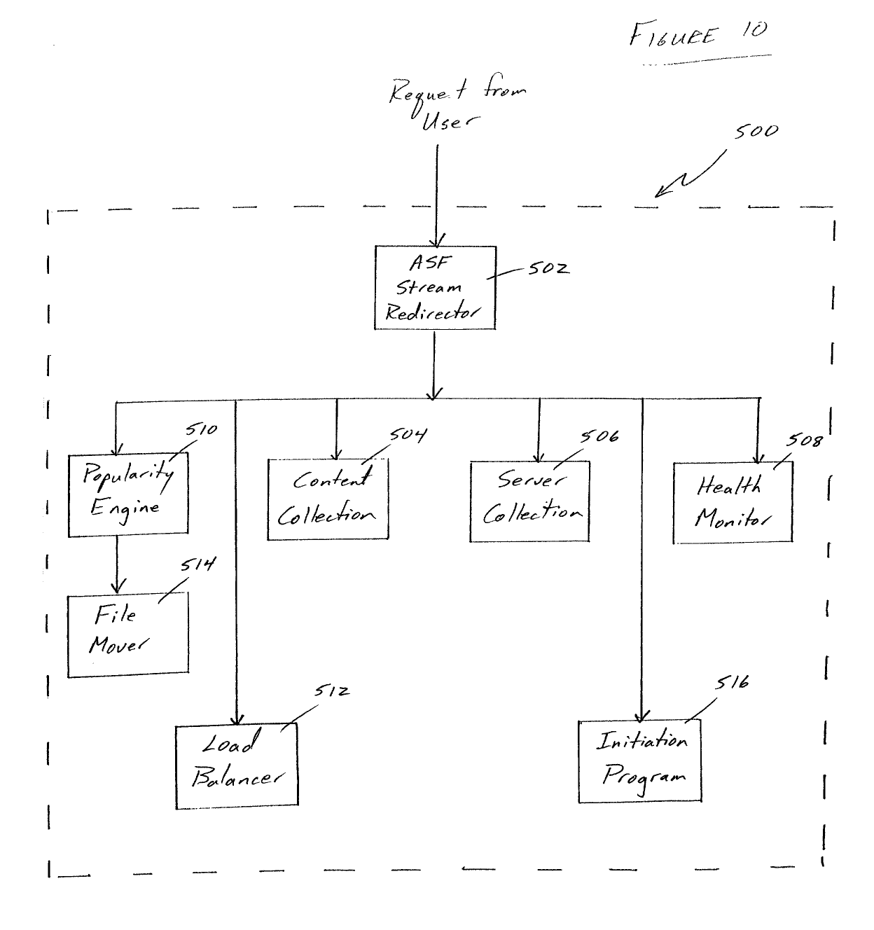

Turning to FIG. 10, a schematic illustration of the operations and interactions of a preferred metaswitch 500 according to the present disclosure is provided. The operations/interactions of metaswitch 500 exemplify operations/interactions of metaswitches 216, 216a and 216b, as described herein. Metaswitch 500 includes an ASF stream redirector 502 (for Windows Media Player) that receives and processes streaming file requests from users. Stream redirector 502 advantageously generates “.asx” files on the fly and communicates the .asx file to the user, thereby directing the user's browser to the desired streaming file. The process by which metaswitch 500 generates individual .asx files in response to individual user requests greatly enhances the overall operation and reliability of the system/method of the present disclosure. As will be apparent from the disclosure that follows, metaswitch 500 optimally directs each individual user to a server that is optimally able to deliver the desired streaming file, and simultaneously tracks the “popularity” of streaming files, i.e., overall user interest in particular streaming files, and optimizes the storage location(s) of such streaming files based on their relative popularity.

With further reference to FIG. 10, metaswitch 500 includes a content collection 504 that communicates with stream redirector 502 and provides information relevant to establishing an optimal .asx file in response to a user request. Content collection 504 contains a list of all streaming files known to metaswitch 500, and the location of each such streaming file within file storage. In a preferred system/method according to the present disclosure, streaming files may be located at least three levels of memory, namely on the network attached storage (\nas), on the hard drive (\hd), and/or on RAM (\ram). Streaming files that are located in RAM memory will generally be more quickly and readily accessed for delivery to a user than streaming files located on the hard drive or on network attached storage. Content collection 504 thus maintains a listing of all streaming files or clips known to metaswitch 500 and the storage location(s) thereof.

In the event a user requests a streaming file from metaswitch 500 that is not recognized by content collection 504, the user is typically advised that the file request is invalid. Alternatively, metaswitch 500 may be programmed to deliver a default streaming file to the user. Thus, according to the system/method of the present disclosure, the first step undertaken by metaswitch 500 in responding to a user request is to query content collection 504 to determine if the requested file is recognized and, if it is recognized, the file storage location(s) of the requested file.

In instances where the requested file is recognized by content collection 504, metaswitch 500 proceeds to determine the optimal server among the redundant array of media servers (RAMS) associated with metaswitch 500 to serve the requested file to the user. Server collection 506 maintains a current listing of operative media servers associated with metaswitch 500 and the relative health of each such media server. According to a preferred embodiment of the present disclosure, each media server among the RAMS contains the same file content, i.e., streaming files are auto-replicated onto all such media servers. Alternatively, it is contemplated that streaming file content may be segregated among and across individual media servers and/or individual media server pools. In embodiments where the file content is segregated, content collection 504 will direct user requests to appropriate server(s)/server pool(s), and server collection 506 will limit its assessment of relative server health to media servers within the designated grouping(s).

Health monitor 508 periodically polls the “health” of media servers associated with metaswitch 500. According to a preferred embodiment of the present disclosure, media server health is based on a plurality of factors aimed at assessing media server performance and, in particular, a media server's ability to handle additional file traffic. Thus, in a preferred embodiment, health monitor 508 advantageously measures three metrics: bandwidth usage, central processor unit (cpu) usage, and late or delayed file reads. The relative weighting of individual metrics may be equal or unequal, based on correlative considerations, as will be apparent to persons skilled in the art. Based on measured performance metrics, health monitor 508 advantageously assigns a health rating on a predetermined scale, e.g., zero (server down) to ten (optimal server health/no users being served).

Health monitor 508 advantageously polls individual media servers on a periodic basis and, to avoid the potential distortive influence of bandwidth spikes and the like. Thus, in a preferred embodiment of the present disclosure, potentially distortive influences are dampened by maintaining or retaining prior metric readings for a preset period of time, and developing a “moving average” of measured metrics. In addition, adjustments to health ratings are preferably not initiated until a plurality of polling cycles demonstrate a change in server health, e.g., three consecutive polling cycles. Thus, health monitor 508 maintains current health ratings for the media servers associated with metaswitch 500, and updates those health ratings based on periodic metric polling of the media servers for performance criteria, such as bandwidth usage, cpu usage and delayed file reads.

Through the interaction of content collection 504, server collection 506 and health monitor 508, metaswitch 500 establishes the optimal media server for delivery of the requested file and the storage location of such requested file within the memory levels associated with such media server. Based thereon, stream generator 502 generates an .asx file that will direct the browser to the desired media server, and transmits such information to the browser of the user. The .asx file generally includes a hierarchy of storage locations to search for the desired media file, based on information contained in the content collection. In the event the desired media file is not located in the primary storage location identified by the content collection, an automatic roll over to the next level of storage automatically occurs, e.g., from RAM to the hard drive. The user's browser is redirected to the appropriate media server location and metaswitch 500 is thereby removed from direct involvement in transfer of the desired streaming file to the user.

In addition to the automatic roll over described with respect to storage levels above, metaswitch 500 further preferably includes a fail-over mechanism that provides further assurance that the user will obtain the desired media file. Thus, if the media server rolls through the available levels of storage, e.g., RAM to hard drive to NAS, without locating the media file for delivery to the user, metaswitch 500 may advantageously include a further fail-over to an alternative media server. The fail-over routing from the initial media server to a back-up media server is generally embedded in the .asx file delivered to the user's browser by stream redirector 502. In a preferred embodiment of the present disclosure, upon automatic redirection to a back-up media server, the browser will begin its search for the desired media file at the initially identified level of storage, e.g., in RAM if that was the storage location searched at the initial media server. Thus, metaswitch 500 is configured to direct a user to an optimal media server for delivery of a requested media file, as described herein, and to further redirect the browser to back-up media server for delivery of the requested file in the event the optimal media server is unavailable or otherwise unable to deliver the desired media file.

Metaswitch 500 advantageously performs a further function related to tracking and responding to the “popularity” of streaming files based on user requests processed thereby. Thus, metaswitch 500 includes a popularity engine 510 that automatically receives input based on request(s) for individual media files. In particular, each time a media file is requested from metaswitch 500, popularity engine 510 is apprised of the file request. Based on cumulative file requests for individual media files, popularity engine 510 is able to monitor how many times particular media files are accessed during a given period of time, e.g., per day, per week, per month, etc. Beyond the advantages associated with optimal media file location, as described below, the tracking of media file popularity provides useful statistical/reporting functionality that may be utilized for conventional market research, marketing and/or other business purposes, as will be readily apparent to persons skilled in the art.

Popularity engine 510 interacts with content collection 504 and file mover 514 within metaswitch 500. As a particular media file registers “hits” from users and surpasses a predetermined threshold level, e.g., every ten hits, popularity engine 510 issues a command to file mover 514 to move the media file to a more readily accessible storage level, e.g., from network attached storage to the hard drive, or from the hard drive to RAM, or from network attached storage to RAM. Thus, as media files become more commonly requested, metaswitch 500 automatically notes the increased relative popularity of such media file and moves such file (e.g., through a DFS copy command) into more readily accessed storage locations. File mover 514 thus responds to command(s) from popularity engine 510 to copy media file(s) into desired memory storage locations.

According to the system/method of the present disclosure, popularity engine 510 additionally automatically monitors the content level within individual storage levels, i.e., RAM, hard drive, NAS, etc. When RAM usage reaches a predetermined threshold level, popularity engine 510 provides a command that causes the least popular media files on RAM to be deleted from RAM memory. Popularity engine 510 also communicates the deletion of such media file from RAM to content collection 504, so as to ensure the most current information concerning media file location is contained in content collection 504. Similarly, popularity engine 510 monitors the degree to which the hard drive(s) associated with metaswitch 500 are nearing saturation, and issues commands causing deletion of the least popular media files contained on the hard drive(s) when a predetermined saturation level is reached. Popularity engine 510 automatically updates content collection 504 upon deletion of media file(s) from hard drive(s) to ensure accurate information within content collection 504.

Metaswitch 500 also generally includes load balancer 514 that functions to select the media server to deliver a media file to a user when all media servers associated with metaswitch 500 are equally healthy, e.g., when the server ratings generated through the server performance metrics described herein are equal. Load balancer 514 typically cooperates with server collection 506 to direct users to media servers according to conventional load distribution techniques, e.g., round robin distribution. Thus, load balancer 514 controls media server selection when server health is a non-determinative factor.

Metaswitch 500 also typically includes an initiation program 516 that initializes the various aspects of metaswitch 500 at start-up. Thus, initiation program 516 initializes content collection 504, server collection 506, health monitor 508 and popularity engine 510 to reflect initial server health, file location and popularity, etc., upon start-up of metaswitch 500 and/or the system/method of the present disclosure.

In operation and upon start-up, metaswitch 500 is initialized by initiation program 516. Thereafter, a user request for a media file is received by metaswitch 500. Content collection 504 is checked to determine if the requested media file is recognized (if not, a default file or “invalid request” message may be forwarded to the user). Assuming the media file is recognized by the content collection, an appropriate pool of media servers possessing the desired media file is identified by content collection 504. In addition, the clip cache level is determined, e.g., NAS, hard drive and/or RAM. Based on the clip cache level location stored within content collection 504, a hierarchy of storage locations to be checked for the desired media file is established, with the most readily accessible storage level being the initial storage location to be searched. If the media file is not located in the initial storage location searched, the hierarchy establishes the rollover sequence to be followed in searching for the media file. In addition, server collection 506 determines the healthiest media server to supply the desired media file, based on information collected by health monitor 508.

ASF system redirector 502 generates an .asx file based on the media server location established by content collection 504 and the optimal media server established by server collection 506. The .asx file is transmitted to the user's browser, which is then redirected to the optimal media server and the appropriate clip cache level to access the desired media file. The media server then commences directly streaming the desired media file to the user.

The user's request for the desired media file is registered in popularity engine 510, which updates the popularity of the media file and makes any appropriate file relocation commands to file mover 514. Popularity engine 510 also monitors the status of the various storage levels to ensure that threshold storage levels are not exceeded. Insofar as threshold levels are reached, popularity engine issues commands to require deletion of “least popular” files contained within storage levels that have exceeded predetermined threshold level(s).

In a further preferred embodiment of the present disclosure, a geoswitch (not pictured) may be provided that communicates and interacts with a plurality of metaswitches, as described herein, to distribute user requests among geographically distributed metaswitches. Thus, the geoswitch may advantageously poll the metaswitches within the network according to the present disclosure, and transfer a user request to the first responding metaswitch, thereby ensuring optimal responsiveness and system utilization. Of note, the polling process employed by a geoswitch according to the present disclosure may result in a metaswitch that is not geographically closest to a particular user being the first to respond, and therefore for the purposes of that user request, the optimal metaswitch to process the user request.

Thus, the metaswitch (and geoswitch) technologies disclosed herein ensure optimal storage of media files, and most efficient handling of user requests. The one-to-one relationship established between the media server that responds to the user request and the user's browser facilitates direct marketing, personalization and related advantageous functionality. Additional advantages and aspects of the disclosed metaswitch/geoswitch technologies, and the operation of the metaswitch/geoswitch technologies within the system/method of the present disclosure will be readily apparent to persons skilled in the art.

While the present disclosure includes a description of the method and system with reference to various specific embodiments, those skilled in the art will readily appreciate that various modifications, changes and enhancements may be made hereto without departing from the spirit or scope of the invention defined by the appended claims.

What is claimed is:

1. A network communication system adapted to deliver a media file to a user, comprising:
a) a plurality of media servers configured as a redundant array of media servers, each of said plurality of media servers communicating with at least two levels of media file storage;
b) a metaswitch that communicates with said redundant array of media servers and is adapted to receive communications from and transmit communications to a user, said metaswitch including:
a stream redirector adapted to redirect a user to one of said plurality of media servers within said redundant array of media servers to access a media file stored therewithin;
a content collection that includes a listing of media files contained within said at least two levels of media storage for said plurality of media servers;
a server collection that includes a listing of said plurality of media servers and a health indicia for each of said plurality of media servers;
a health monitor that is adapted to periodically collect measurements related to predetermined performance metrics for said plurality of media servers, and to update the health indicia for said plurality of media servers within said server collection based on said periodic collection of predetermined performance metrics; and
a popularity engine that is adapted to track user requests for media files that are stored within said at least two levels of media storage and to command repositioning of said media files based upon said tracking of user requests; and
a file mover that is adapted to respond to commands from said popularity engine and to reposition media files within said at least two levels of media storage;
c) wherein said stream redirector redirects a user to one of said at least two levels of media file storage for one of said plurality of media servers to access a requested media file, based on input from said content collection and said server collection.

2. A network communication system according to claim 1, wherein said stream generator generates an .asx file to redirect a user.

3. A network communication system according to claim 1, wherein said metaswitch further comprises a load balancer, said load balancer providing an alternative source of input to said stream redirector for redirection of users to one of said plurality of media servers when said health indicia contained within said server collection is non-determinative.

4. A network communication system according to claim 1, wherein said predetermined metrics are selected from the group consisting of bandwidth usage, central processor unit usage, late reads of media files, and combinations thereof.

5. A network communication system according to claim 1, wherein said at least two levels of media file storage are selected from the group consisting of RAM storage, hard drive storage, and network attached storage.

6. A network communication system according to claim 1, wherein said listing of media files within said content collection is updated based on tracking of user requests by said popularity engine.

7. A network communication system according to claim 1, wherein said plurality of media servers are grouped into server pools based on media files associated therewith.

8. A network communication system according to claim 1, wherein said health monitor dampens adjustments to health indicia for said plurality of media servers by averaging performance metrics across successive measurements, thereby minimizing the impact of bandwidth spikes.

9. A network communication system according to claim 1, wherein said stream redirector provides a user with a hierarchy of levels of media file storage for access to media files.

10. A network communication system according to claim 1, wherein said popularity engine is further adapted to monitor file storage levels within said at least two levels of media storage and to command removal of media files therefrom based on preset threshold file levels.
